(19) United States
(12) Patent Application Publication
(10) Pub. No.: US 2008/0052093 A1
(43) Pub. Date: Feb. 28, 2008

(54) METHODS AND APPARATUS FOR OPERATING AN INTERMODEL FACILITY

(75) Inventors: Brian Swindle, Sugar Grove, IL (US); Paul Fisher, Oak Park, IL (US); Michael Mullen, Northbrook, IL (US); Daniel Hemmer, Hinsdale, IL (US); James Ford, Lisle, IL (US)

Correspondence Address: BELL, BOYD & LLOYD, LLP, P.O. Box 1135, CHICAGO, IL, 60690, US

(73) Assignee: CENTERPOINT REALTY SERVICES, INC., Oak Brook, IL (US)

(21) Appl. No.: 11/467,042

(22) Filed: Aug. 24, 2006

(51) Int. Cl. G06Q 10/00; G06Q 30/00

(52) U.S. Cl. 705/1

(57) ABSTRACT

Methods and apparatus to operate an intermodal facility are disclosed. In the method described herein, a carrier enters into a contractual agreement with a separate intermodal facility owner to have exclusive use of the intermodal facility. Alternatively, a rail-to-truck and/or truck-to-rail intermodal facility owner may provide non-exclusive use to multiple railroads. Preferably, the carrier has no minimum use requirements associated with the intermodal facility. For example, the carrier is not required to transfer a certain number of containers in a certain period of time, and the carrier does not have to pay a periodic fee to the intermodal facility owner. Instead, the shipper associated with the carrier is charge by the intermodal facility owner based on the amount of intermodal facility use (e.g., on a per container basis). In one embodiment, a real estate developer is the intermodal facility owner. In addition, the real estate developer preferably builds a business park near the intermodal facility in order to capture the related business.

### TECHNICAL FIELD

The present disclosure relates in general to transportation, and, in particular, to methods and apparatus for operating an intermodal facility.

### BACKGROUND

Shipping containers are standard size metal boxes that can be efficiently moved from one mode of transportation to another mode of transportation without unloading the contents of the container. For example, a container of clocks made in China can be shipped across the ocean and then placed on to a truck chassis to be distributed to a plurality of retailers. In fact, many standard shipping containers are approximately the size of a typical truck trailer. For example, standard shipping container dimensions include a height of 8 feet, 6 inches, a width of 8 feet, and a length of 20 feet, 28 feet, 40 feet, or 48 feet. Other container sizes may also be used. For example, many containers are sized to efficiently accommodate a certain number of shipping pallets.

Shipping containers also come in many different types. For example, some containers are just a metal box with a door on one end. Some containers also included side doors. Other containers are insulated and/or temperature controlled. Temperature control equipment may be mounted inside the container or outside the container and may use an internal or external power source. There are also many special purpose containers, such as tank containers and flat racks.

Each container includes a registration number. The registration number identifies the container owner and the particular unit for that owner. Typically, each container also includes a classification number. The classification number indicates the type of container (e.g., a 40 foot insulated container).

Shipping containers include fittings at lift points on the top and bottom of the container to facilitate stacking and moving of the containers. The fittings are oval shaped holes. When containers are stacked for storage or transportation, the containers are connected together by inserting an inter-box connector in the oval holes of adjacent containers (i.e., the top of one and the bottom of another). The inter-box connectors are then turned to lock the two containers together.

An intermodal facility is used to move containers from one mode of transportation to another mode of transpiration. Modes of transportation include by truck, by rail road, by ship (ocean vessel or barge), by airplane, etc. When containers are moved by truck, a special chassis is used. A chassis is a framework with wheels. When a container is attached to the chassis, the result is similar to a standard truck trailer. Many chassis are adjustable to accommodate different container lengths. When containers are moved by rail road, two containers may be stacked if the route includes the appropriate clearances. When containers are moved by ship, many containers may be stacked.

An intermodal facility typically includes special container handling cranes that can quickly and precisely move the containers from one mode of transportation to another mode of transportation. For example, a ship to shore operation typically includes a crane with an adjustable spreader bar. This crane may also be able to verify the weight of the container.

These intermodal facilities are expensive to build and maintain. Typically, intermodal facilities at ports are owned by a municipality or a port authority and are used by several different shippers and/or carriers. However, this may cause an access problem for a carrier if the intermodal facility is too busy. If a particular carrier wants exclusive use of an intermodal facility, that carrier typically must own the intermodal facility. For example, railroads typically own their own rail-to-truck and/or truck-to-rail intermodal facilities. However, this causes the large building expense of the intermodal facility to be on the carrier's books (e.g., $100 million). In addition, the carrier runs additional financial risk if the intermodal facility is underused.

### SUMMARY

In the method described herein, a carrier enters into a contractual agreement with a separate intermodal facility owner to have exclusive use of the intermodal facility. Alternatively, a rail-to-truck and/or truck-to-rail intermodal facility owner may provide non-exclusive use to multiple railroads. Preferably, the carrier has no minimum use requirements associated with the intermodal facility. For example, the carrier is not required to ship a certain number of containers in a certain period of time, and the carrier does not have to pay a periodic fee to the intermodal facility owner. Instead, the carrier is charge based on the amount of intermodal facility use (e.g., on a per container basis).

In one embodiment, a real estate developer is the intermodal facility owner. The real estate developer selects a location and builds the intermodal facility for use by one or more carriers. In addition, the real estate developer preferably builds a business park near the intermodal facility in order to capture the related business for one or more shippers and/or carriers. Alternatively, the real estate developer or other intermodal facility owner may acquire ownership of the intermodal facility in any suitable manner.

Additional features and advantages are described herein, and will be apparent from, the following Detailed Description and the figures.

### BRIEF DESCRIPTION OF THE DRAWINGS

FIG. 1 is a high level block diagram of an intermodal facility.

FIG. 2 is a flowchart of an example method of operating an intermodal facility.

### DETAILED DESCRIPTION OF EXEMPLARY EMBODIMENTS

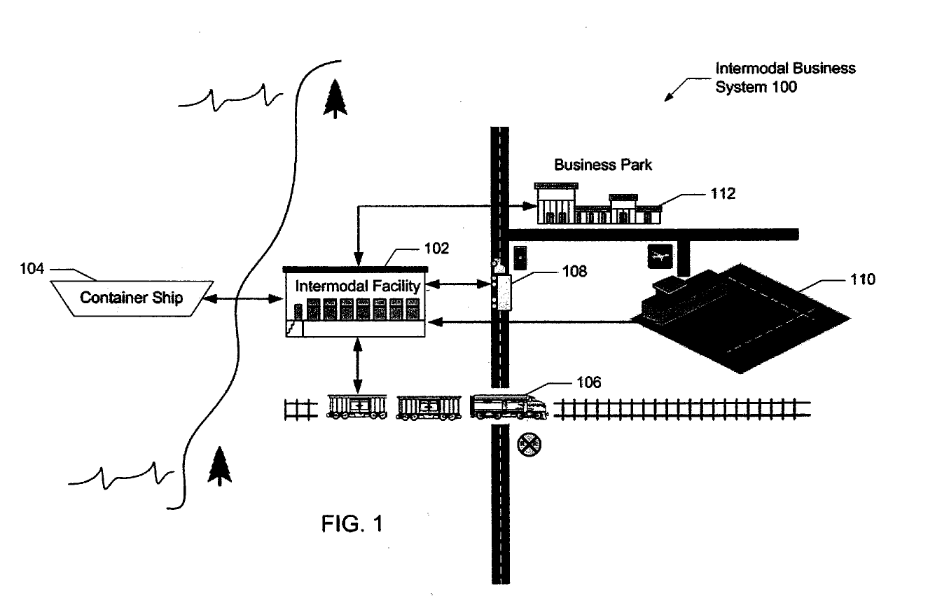

A block diagram of an example intermodal business system 100 is illustrated in FIG. 1. In this example, an intermodal facility 102 moves cargo between container ships 104, railroad cars 106, trucks 108, an airport 110, and a business park 112. It will be appreciated that cargo may be moved between any two or more suitable transportation systems.

Often, containers are not transferred directly from one mode of transportation (e.g., a container ship 104) to another mode of transportation (e.g., a railroad car 106), because the preferred unloading sequence for one mode may not coincide with the preferred loading sequence for another mode. Additionally, containers from one mode may be going on different modes to different destinations. In addition, the intermodal facility 102 may be used to transfer containers from one carrier to another carrier where both carriers are using the same mode of transportation.

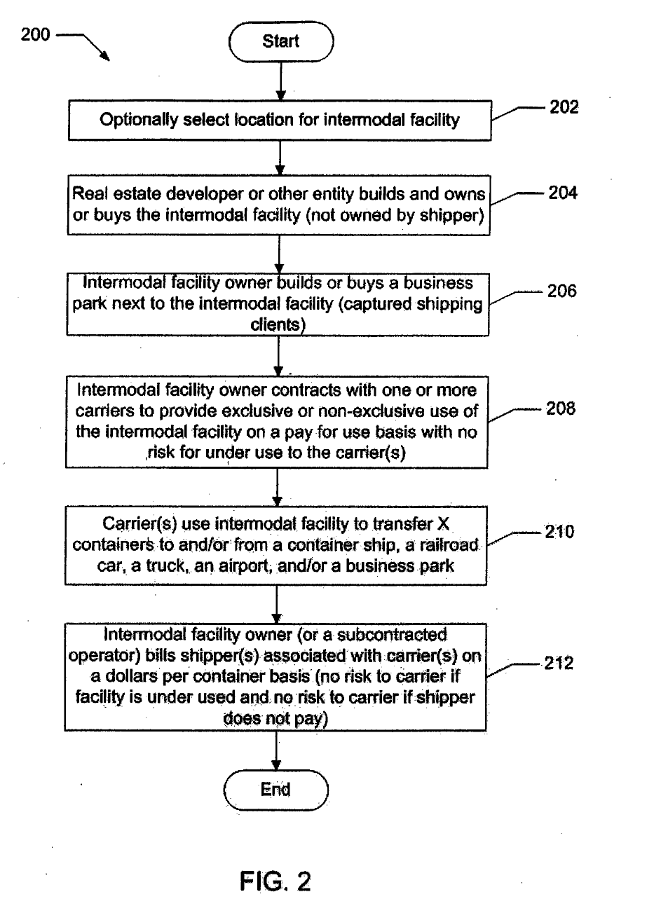

A process 200 for operating an intermodal facility 102 is illustrated in FIG. 2. The process 200 begins when a intermodal facility owner selects a location for the intermodal facility 102 (block 202). For example, a real estate developer and/or a carrier may select a location based on a particular need. Although a real estate developer is used an intermodal facility owner in the examples described herein, it will be appreciated that any suitable business entity may own the intermodal facility.

Once a location for the intermodal facility 102 is selected, the intermodal facility owner (e.g., real estate developer) builds the intermodal facility 102 and retains ownership (block 204). Alternatively, the intermodal facility owner may purchase an existing intermodal facility 102. In either case, the intermodal facility 102 is not owned by the carrier (e.g., not by the railroad).

In addition, the intermodal facility owner preferably builds and/or buys a business park 112 near the intermodal facility 102 (block 206). In this manner, the carrier associated with the intermodal facility 102 is likely to receive shipping business from the businesses in the business park 112.

The carrier associated with the intermodal facility 102 enters into an agreement with the intermodal facility owner to have exclusive use of the intermodal facility 102 (block 208). Alternatively, a rail-to-truck and/or truck-to-rail intermodal facility owner may provide non-exclusive use to multiple railroads. Preferably, the carrier has no minimum use requirements associated with the intermodal facility 102. For example, the carrier is not required to ship a certain number of containers in a certain period of time, and the carrier does not have to pay a periodic fee to the intermodal facility owner. In this manner, the intermodal facility owner, not the carrier, bears the risk of underutilization of the intermodal facility.

Different rates may apply to different types of intermodal transfer. For example, one rate may apply to transferring cargo from a container ship 104 to a railroad car 106, and another rate may apply to transferring cargo from a railroad car 106 to a truck 108. In another example, one rate may apply for standard size containers, and another rate may apply to unit load devices (i.e., aircraft containers).

The carrier then uses the intermodal facility 102 to transfer containers from one mode of transportation to another mode of transportation (block 210). For example, the carrier may use the intermodal facility 102 to transfer containers to and/or from a container ship 104, a railroad car 106, a truck 108, an airport 110, and/or the business park 112.

As the carrier uses the intermodal facility 102, the intermodal facility owner (or a subcontracted intermodal operator) bills the shipper associated with the carrier for the use (block 212). For example, the intermodal facility owner may charge the shipper on a per container basis. In this manner, the intermodal facility owner, not the carrier, bears the risk of non-payment by the shipper.

In summary, persons of ordinary skill in the art will readily appreciate that methods and apparatus for operating an intermodal facility have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention not be limited by this detailed description of examples.

What is claimed is:

1. A method of providing an intermodal service, the method comprising:
acquiring ownership of an intermodal facility by a first business entity;
executing a contract between the first business entity and a second business entity, the contract obligating the first business entity to give exclusive use of the intermodal facility to the second business entity;
providing an amount of use of the intermodal facility to the second business entity; and
charging the second business entity based on the amount of the use.

2. The method of claim 1, wherein acquiring ownership of the intermodal facility by the first business entity includes purchasing the intermodal facility by the first business entity.

3. The method of claim 2, including purchasing land associated with the intermodal facility by the first business entity.

4. The method of claim 1, wherein acquiring ownership of the intermodal facility by the first business entity includes building the intermodal facility by the first business entity.

5. The method of claim 4, including purchasing land associated with the intermodal facility by the first business entity.

6. The method of claim 1, wherein the contract between the first business entity and the second business does not include a provision indicating that there is a minimum fee obligation imposed on the second business entity.

7. The method of claim 1, wherein the contract between the first business entity and the second business entity does not include a provision indicating that there is a minimum use obligation imposed on the second business entity.

8. The method of claim 1, wherein the contract between the first business entity and the second business entity does not include a provision indicating that there is a non-use based fee imposed on the second business entity.

9. The method of claim 1, wherein the contract between the first business entity and the second business entity includes a provision indicating that there is no minimum fee obligation imposed on the second business entity.

10. The method of claim 1, wherein the contract between the first business entity and the second business entity includes a provision indicating that there is no minimum use obligation imposed on the second business entity.

11. The method of claim 1, wherein the contract between the first business entity and the second business entity includes a provision indicating that there is no non-use based fee imposed on the second business entity.

12. The method of claim 1, wherein charging the second business entity based on the amount of the use includes charging the second business entity on a per container basis.

13. The method of claim 1, wherein the intermodal facility is structured to transfer cargo from a container ship to a railroad car.

14. The method of claim 1, wherein the intermodal facility is structured to transfer cargo from a railroad car to a container ship.

15. The method of claim 1, wherein the intermodal facility is structured to transfer cargo from a container ship to a truck.

16. The method of claim 1, wherein the intermodal facility is structured to transfer cargo from a truck to a container ship.

17. The method of claim 1, wherein the intermodal facility is structured to transfer cargo from a railroad car to a truck.

18. The method of claim 1, wherein the intermodal facility is structured to transfer cargo from a truck to a railroad car.

19. The method of claim 1, wherein the intermodal facility is structured to transfer cargo from a container ship to an airport.

20. The method of claim 1, wherein the intermodal facility is structured to transfer cargo from an airport ship to a container ship.

21. The method of claim 1, wherein the intermodal facility is structured to transfer cargo from a railroad car to a airport.

22. The method of claim 1, wherein the intermodal facility is structured to transfer cargo from an airport ship to a railroad.

23. The method of claim 1, wherein the intermodal facility is structured to transfer cargo from a truck to a airport.

24. The method of claim 1, wherein the intermodal facility is structured to transfer cargo from an airport ship to a truck.

25. The method of claim 1, wherein the intermodal facility is structured to transfer cargo to and from a container ship, a railroad car, a truck, and an airport.

26. The method of claim 1, including acquiring ownership of a business park by the first business entity, the business park being located within five miles of the intermodal facility.

27. The method of claim 26, wherein acquiring ownership of the business park by the first business entity includes purchasing the business park by the first business entity.

28. The method of claim 27, including purchasing land associated with the business park by the first business entity.

29. The method of claim 26, wherein acquiring ownership of the business park by the first business entity includes building the business park by the first business entity.

30. The method of claim 29, including purchasing land associated with the business park by the first business entity.

31. The method of claim 26, wherein the intermodal facility is structured to transfer cargo from a container ship to the business park.

32. The method of claim 31, wherein the intermodal facility is structured to transfer cargo from the business park to a container ship.

33. The method of claim 26, wherein the intermodal facility is structured to transfer cargo from a railroad car to the business park.

34. The method of claim 33, wherein the intermodal facility is structured to transfer cargo from the business park to a railroad car.

35. The method of claim 26, wherein the intermodal facility is structured to transfer cargo from a truck to the business park.

36. The method of claim 35, wherein the intermodal facility is structured to transfer cargo from the business park to a truck.

37. The method of claim 26, wherein the intermodal facility is structured to transfer cargo from an airport to the business park.

38. The method of claim 37, wherein the intermodal facility is structured to transfer cargo from the business park to an airport.

39. The method of claim 26, wherein the intermodal facility is structured to transfer cargo to and from a container ship, a railroad car, a truck, an airport, and the business park.

40. A method of providing an intermodal service, the method comprising:
purchasing land;
developing an intermodal facility and a business park on the land;
providing exclusive use of the intermodal facility to a business entity;
moving a number of containers from a first mode of transportation to a second different mode of transportation at the intermodal facility for the business entity; and
charging the business entity based on the number of containers.

41. The method of claim 40, wherein the exclusive use of the intermodal facility is not associated with a minimum fee.

42. The method of claim 40, wherein the intermodal facility is structured to transfer cargo to and from a plurality of railroad cars and a plurality of trucks.

43. A method of providing an intermodal service, the method comprising:
acquiring ownership of an intermodal facility by a first business entity;
moving a first number of containers between a first plurality of railroad cars and a first plurality of trucks at the intermodal facility for a second business entity;
charging the second business entity based on the first number of containers;
moving a second number of containers between a second plurality of railroad cars and a second plurality of trucks at the intermodal facility for a third business entity; and
charging the third business entity based on the second number of containers.

44. The method of claim 43, wherein the first business entity is not a railroad.
